(19) United States
(12) Patent Application Publication
(10) Pub. No.: US 2008/0081227 A1
(43) Pub. Date: Apr. 3, 2008

(54) Gas Phase Fuel Cells

(75) Inventors: Alex Mossman, Vancouver (CA); Brian Wells, Vancouver (CA); Russell Barton, New Westminster (CA)

Correspondence Address: MORGAN, LEWIS & BOCKIUS, LLP, ONE MARKET SPEAR STREET TOWER, SAN FRANCISCO, CA, 94105, US

(73) Assignee: Polyfuel, Inc., Mountain View, CA (US)

(21) Appl. No.: 11/745,341

(22) Filed: May 7, 2007

Related U.S. Application Data
(60) Provisional application No. 60/798,273, filed on May 5, 2006.
(60) Provisional application No. 60/851,182, filed on Oct. 11, 2006.
(60) Provisional application No. 60/864,767, filed on Nov. 7, 2006.

(51) Int. Cl. H01M 8/10

(52) U.S. Cl. 429/13; 429/30

(57) ABSTRACT

The invention provides gas phase fuel cells for use in such fuel cells and methods of operating such fuel cells.

### TECHNICAL FIELD

This invention relates to gas phase fuel cells, especially gas phase methanol fuel cells. This application claims the benefit of U.S. Provisional Application Ser. No. 60/798,273 and is being filed under 35 U.S.C. §119 and is incorporated by reference in its entirety herein.

### BACKGROUND OF THE INVENTION

Fuel cells are promising power sources for portable electronic devices, electric vehicles, and other applications due mainly to their non-polluting nature. Of various fuel cell systems, polymer electrolyte membrane based fuel cells such as direct methanol fuel cells (DMFCs), have attracted significant interest because of their high power density and energy conversion efficiency. In direct methanol fuel cells methanol and water are supplied directly to the fuel cell anode.

### SUMMARY OF THE INVENTION

The invention includes a gas phase methanol fuel cell system that contains (1) one or more fuel cell assemblies each having a fuel entry port, a fuel flow field and an exhaust port, and (2) an anode recirculation loop defined by (i) the fuel flow fields, (ii) a conduit having a first end in fluid communication with the exhaust port(s) and a second end in fluid communication with the fuel inlet port(s); and (iii) a vent between the first and second ends to vent gases from the anode loop.

Components or combinations of components of the fuel cell system include membrane electrode assemblies (MEAs) having an anode GDL, a cathode GDL, a polymer electrolyte membrane (PEM) between the anode GDL and the cathode GDL, and a catalyst layer interposed between the anode GDL and the PEM and between the cathode GDL and the PEM. In some embodiments, the cathode GDL has restricted diffusivity to water so that when the MEA is used in an operating methanol vapor fuel cell at least a portion of the water produced at the cathode diffuses across said PEM to the anode in an amount sufficient to humidify the PEM and provide water for the anode reaction.

The MEA can have an anisotropic GDL associated with the anode that is designed to maintain the concentration of a gas phase fuel, such as methanol gas at the anode catalyst layer as fuel is consumed along the anode surface. An example of an anisotropic GDL is a layer of conductive non-metallic material having a plurality of gas diffusion pores, where the layer has increased gas diffusivity in at least a first direction.

In some cases, the above cathode GDLs and anisotropic GDLs can be used in combination with the same PEM.

A fuel cell system can be made by placing the above MEA between first and second fuel cell plates to form a fuel cell assembly that has a fuel flow field and fuel entry and exhaust ports. The system also includes a fuel injection assembly in fluid communication with the fuel inlet port the fuel injection assembly is adapted to be in fluid communication with liquid fuel from a fuel source. Waste heat from the electrochemical reaction within the fuel cell system can be used to facilitate the transition of liquid fuel to the gas phase either within the anode (fuel) recirculation loop or in a fuel injection assembly, if used.

The fuel cell system preferably contains an anode recirculation loop. The loop is defined by (i) the fuel flow field(s), (ii) a conduit having a first end in fluid communication with the exhaust port(s) and a second end in fluid communication with the fuel injection assembly which is in fluid communication with the fuel flow field inlet port; and (iii) a vent between said first and second ends to vent gases from the anode loop.

The invention also includes fuel cells comprising the above fuel cell system as well as electronic devices, power supplies and electric motors utilizing such fuel cells.

The invention is also directed to methods of operating a fuel cell system containing at least one fuel cell assembly and a liquid fuel supply. The method comprises (1) vaporizing methanol or other volatile fuel from a liquid fuel supply using waste heat from at least one fuel cell assembly or heat from a separate heat source; and (2) directing the vaporized fuel to at least one fuel cell assembly.

In another embodiment, the invention includes methods of operating a vapor phase fuel cell system having a fuel cell assembly comprising: (1) an anode comprising a catalyst layer, a fuel entry port, a fuel flow field in fluid communication with the anode, and a fuel exhaust port; (2) a cathode comprising a catalyst layer, an oxidant entry port, an oxidant flow field in fluid communication with the cathode, and an oxidant exhaust port; and (3) an anode recirculation loop in fluid communication with the fuel exhaust port and the fuel inlet port. The method comprises: (i) directing an oxidant stream to at least one fuel cell cathode via the oxidant entry port; (ii) directing a gaseous fuel, such as methanol gas, to a least one fuel cell anode via the fuel entry port; (iii) operating the fuel cell assembly so that water is produced at the cathode and carbon dioxide is produced at the anode; and (iv) recirculating a gaseous anode exhaust stream containing fuel vapor and carbon dioxide in the anode recirculation loop; and (v) venting of at least a portion of the carbon dioxide during recirculation by a carbon dioxide separator or a vent in fluid communications with the recirculating anode exhaust stream.

The concentration of methanol in the recirculated gaseous anode exhaust stream is preferable less than about 10 volume %, more preferably less than about 5 volume %.

### DESCRIPTION OF THE DRAWINGS

FIG. 1 is a system diagram of an embodiment that uses a combined coolant oxidant cathode gas stream which has a cathode GDL incorporating properties to retain sufficient water so as to induce water diffusion from the cathode to the anode for reaction with a gaseous fuel. An anisotropic anode GDL can also be used in this system. The temperatures shown in the diagram are shown only for illustrative purposes, other operating temperatures of the fuel cell stack and temperatures for the ambient air may be utilized.

FIG. 2 depicts the controlled pressure drop in each leg of a flow splitter compared with the low pressure drop in the fuel cell fluid passages.

FIG. 3 depicts the concentrations of methanol, water, oxygen and carbon dioxide across a membrane electrode assembly.

FIG. 4 shows the concentration of methanol, carbon dioxide along a fuel channel from inlet to exit in the channel and at the catalyst layer using an anisotropic GDL. It also depicts the porosity of the anisotropic anode GDL as it increases from the channel inlet to the channel outlet.

FIG. 5 depicts a fuel cell system in one embodiment of the invention. The dashed line defines the anode loop.

FIG. 6 is a section plate showing a fuel limiter 10 in plotting resin 20. A fuel feed header 30 is in fluid communication with fuel channels 40. Air channels 50 are on the opposing surface of the plate and are perpendicular to the fuel channels 40.

FIG. 7 is a fuel cell stack made of the plates of FIG. 6. The fuel is introduced to the stack via a distribution passage 60 where it is metered through the flow limiters 10 in the individual plates to heater 30 and into fuel channels 40.

FIG. 8 depicts the performance of a gas phase fuel cell under Known anode vapor conditions.

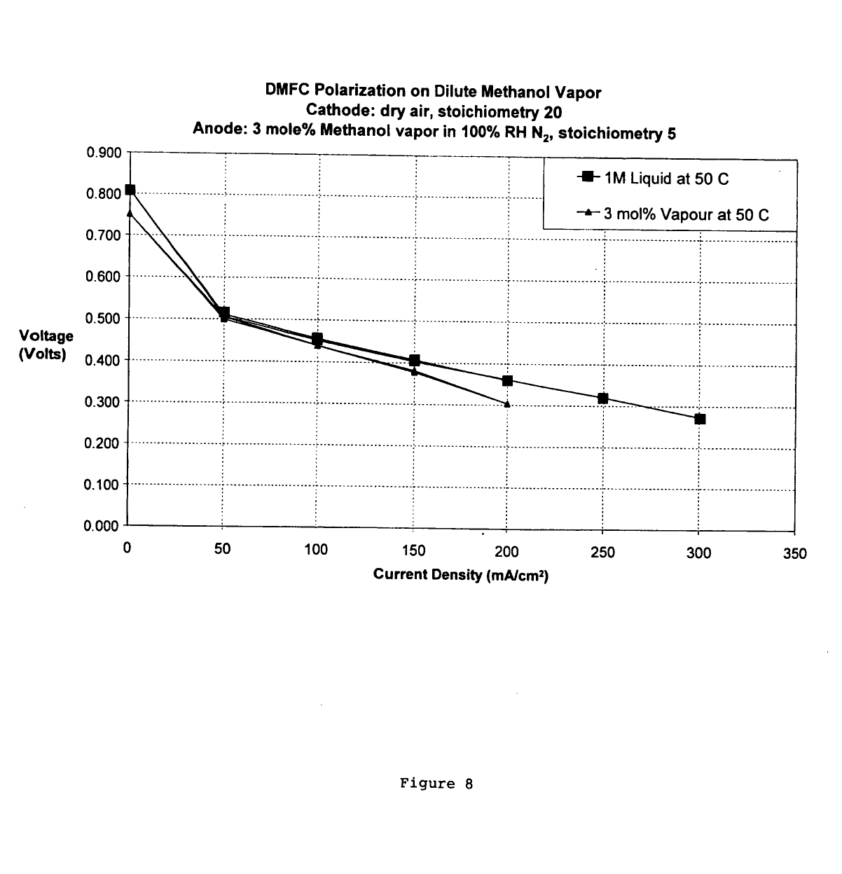

FIG. 9 depicts the performance of a gas (vapor) phase DMFC as a function of fuel vapor concentration.

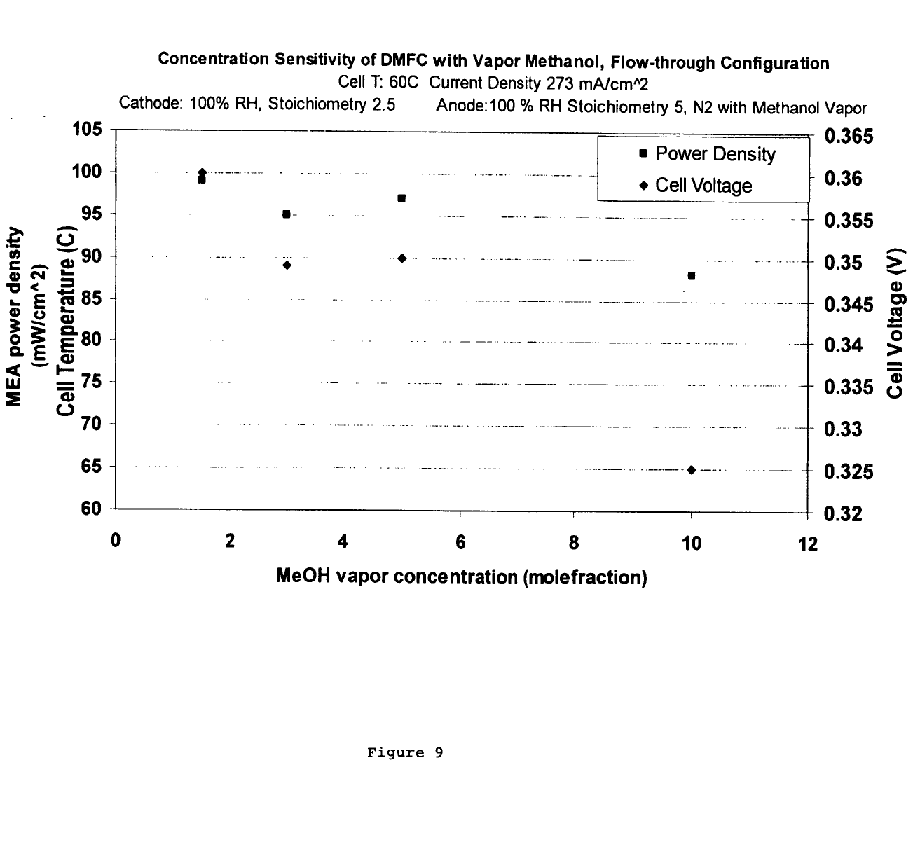

FIG. 10 depicts the performance of a gas (vapor) phase DMFC utilizing an anode recirculation loop.

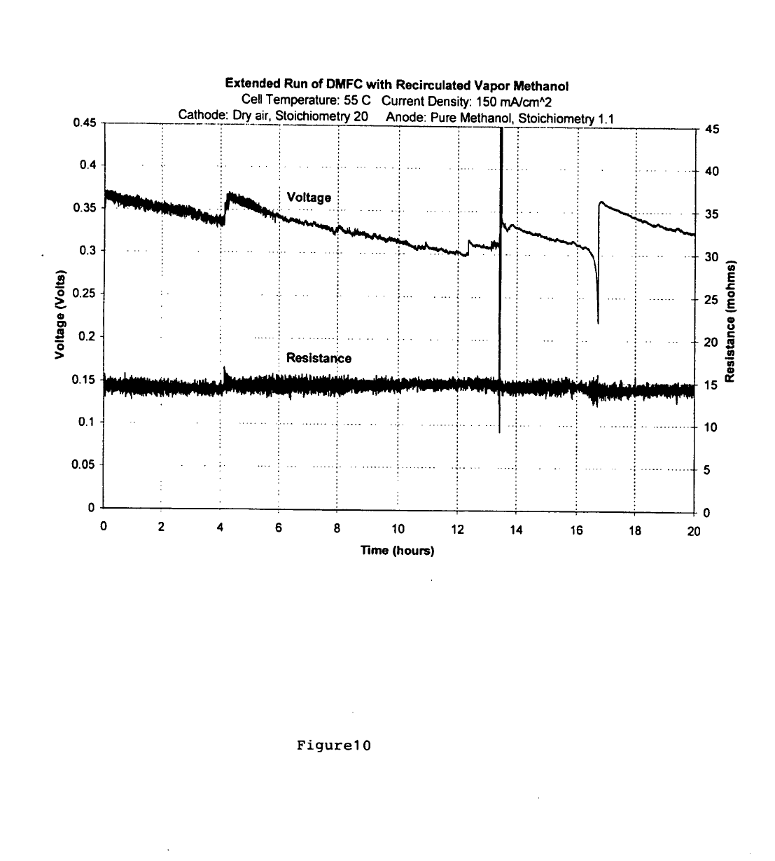

### DETAILED DESCRIPTION OF THE INVENTION

The invention relates to gas phase (sometimes referred to as vapor phase) fuel cells, and in particular to gas phase direct methanol fuel cells (DMFC) in which methanol is directed to the anode substantially as a gas. The methanol is generally stored as a liquid in the system and converted to a gas (vaporized) before or as it is delivered to the fuel cell anode(s). The invention also relates to fuel cell components that offer particular advantages in such gas phase fuel cells, and to methods for operating gas phase fuel cell systems. Such components include: an anode recirculation loop, a PEM used with a cathode GDL that facilitate water diffusion from the cathode to the anode; and A PEM used with anisotropic GDLs to maintain fuel concentration at the anode. Other components include membrane electrode assemblies, fuel injection assemblies and fuel cell systems containing such assemblies.

I. Anode Recirculation Loop

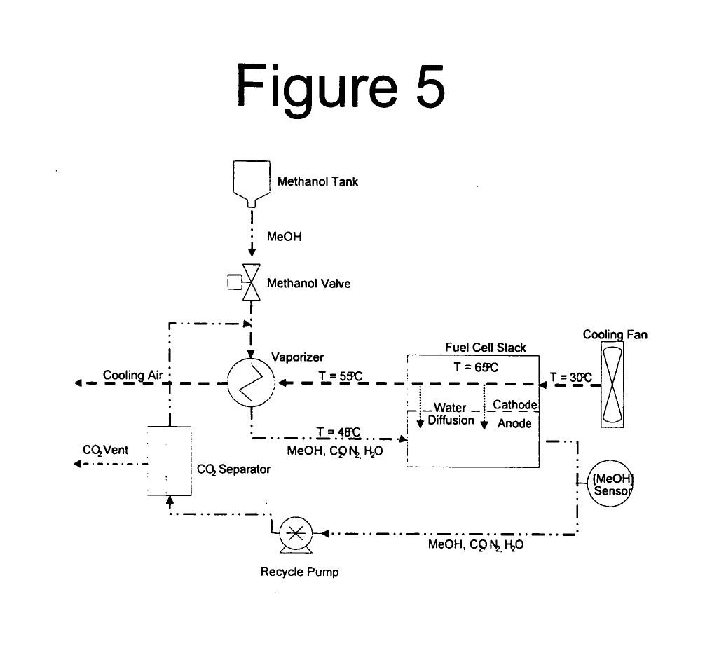

In a preferred embodiment methanol is recirculated as vapor in an anode loop with carbon dioxide (CO₂), which is a product of the anode reaction. The methanol which is supplied to the recirculating fuel stream can be vaporized using waste heat from the electrochemical reaction. The effect of using carbon dioxide as a diluent gas is to reduce the concentration of the methanol vapor in the recirculated fuel stream such that the methanol concentration is low enough at the electrochemical interface, so as to reduce the rate at which methanol permeates the polymer electrolyte membrane and reacts directly with oxygen molecules at the cathode (referred to as methanol crossover), but high enough to permit robust load-following operation due to the high diffusion rate of methanol molecules in the vapor state. This load-following can be further described as the near constant concentration of methanol vapor across the anode electrochemical reaction area over a wide range of electrochemical reaction rates. Such vapor phase fuel cells are therefore useful in fuel cell power generators for which the power output and therefore reaction rate is typically not constant. In practicing this aspect of the invention, the methanol content of the recirculated gas stream is preferably below about 10 volume % or more preferably below about 5 volume %. As measured upstream from the fuel inlet ports(s). An example of an anode loop can be seen in FIG. 5 as delineated by the dashed line.

II. Cathode Gas Diffusion Layers (GDLs)

Fuel cells using fuels which are not diluted in water are clearly advantageous because less volume is needed to store the same amount of oxidizable fuel. With fuels (liquid or vapor) having a low water content, it is preferred that the MEAs also have cathode GDLs that have water diffusivity that limits the escape of water formed at the cathode. This is necessary because water is required to maintain sufficient ion conductivity of the polymer electrolyte membrane and for some carbon based fuels, water may also be consumed at the anode. When the carbonaceous fuel does not contain significant amounts of water, a portion of the water formed during the reduction of oxygen at the cathode may be used to support the oxidation reaction at the anode, if so required. In a preferred embodiment, the cathode GDL's water diffusivity is chosen to as to humidify the PEM and also to provide water via diffusion across the PEM for the anode reaction. For example, when pure methanol is used as the fuel, one molecule of methanol reacts with one molecule of a water to form CO₂, six protons and six electrons. The six electrons provide a current through a load to the cathode, while the six protons traverse the PEM to the cathode. At the cathode, the six protons, six electrons and oxygen combine to form three water molecules. Overall, one molecule of water is consumed on the anode side while three molecules of water are formed on the cathode side. If no water is present in the methanol fuel, one of the three water molecules produced at the cathode must be transported across the PEM to the anode in order for the oxidation reaction to continue. Under these circumstances, the cathode GDL diffusivity is chosen so that it limits the amount of water crossing the cathode GDL to the air exhaust so as to increase the diffusion of water to the anode side of the PEM. An example of such a cathode GDL is disclosed in the aforementioned U.S. Pat. No. 6,457,470

III. Anisotropic GDLs

In another aspect, the invention relates to anisotropic GDL that are characterized by non-uniform gas diffusivity. The anisotropic GDL demonstrates a change in gas diffusivity as one traverses the anisotropic GDL in at least one direction. The change in diffusivity can be continuous or can occur in steps across the anisotropic GDL with lower diffusivity near the areas of higher fuel (or reactant species) concentration, and lower diffusivity in areas of lower fuel (or reactant species) concentration. Such anisotropic GDLs can be used in gas phase fuel cells, preferably associated with the anode.

An anisotropic GDL can be manufactured in at least two different ways (e.g., by modifying the disclosure in U.S. Pat. No. 6,451,470 and U.S. Patent Publication 2003/0138689 each incorporated by reference). In one method, a sheet of flexible graphite material is perforated by a tool containing multiple teeth. If a reciprocating tool is used, the tooth size, or tooth spacing can both be varied in order to produce any desired pattern of porosity in the X-Y plane of the flexible graphite sheet.

In a second method, a sheet of carbon fiber GDL material is printed or otherwise coated and/or impregnated with an ink consisting of Teflon®, graphite, or other inert filler materials. The amount of filler applied to any area of the GDL will determine its porosity, and consequently its through-plane diffusivity. By coating different amounts of filler onto different areas of a sheet (for example by repeated screen printing with different patterns), an arbitrary distribution of through-plane diffusivity can be created.

The anisotropic GDL may be used to make Membrane Electrode Assemblies (MEAs). The MEA contains a polymer electrolyte membrane (PEM) that has opposing first and second surfaces. The MEA also includes at least a first catalyst layer disposed on one of the PEM surfaces and an anisotropic GDL disposed directly or indirectly on the first catalyst layer. Alternatively, a first catalyst layer can be disposed on one surface of the anisotropic GDL, and the PEM can be disposed directly or indirectly on the catalyzed GDL surface.

IV. Fuel Cell Systems

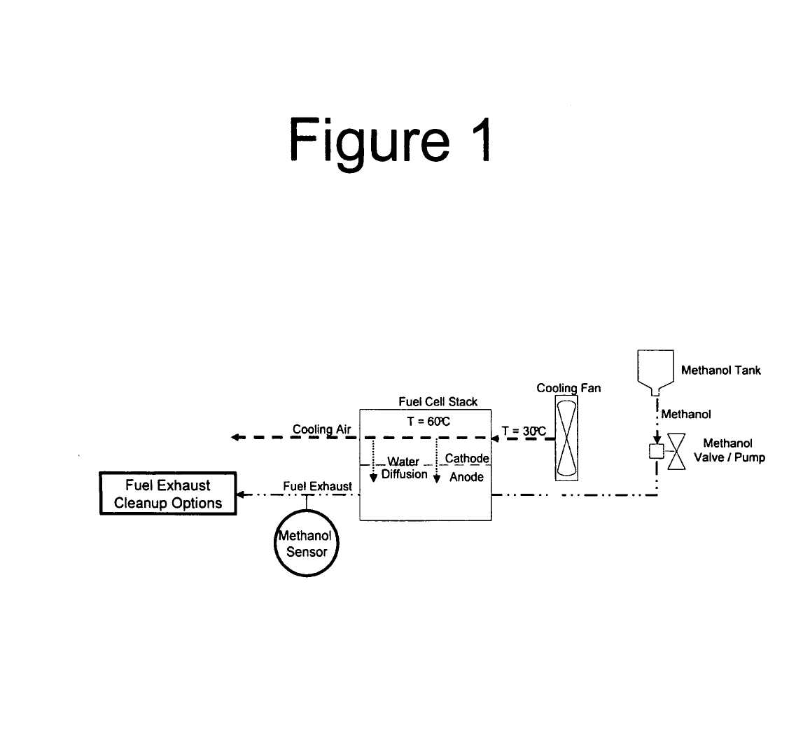

The fuel cell systems contain a fuel cell assembly, a fuel injector (optional) and preferably an anode recirculation loop. The MEA is disposed between first and second fuel cell plates to form a fuel cell assembly. One of the fuel cell plates has features on at least one of its surfaces so that when combined with the anode surface of the MEA a fuel flow field is defined having a fuel entry port and an exhaust port. If an anisotropic MEA is used, it is disposed between the plates so that the anisotropic GDL is oriented with the fuel flow field so that the gas diffusion rate of the anisotropic GDL is lowest at or near the fuel entry port and highest at or near the exhaust port. The effect of this orientation is to maintain a concentration of fuel vapor at the surface of the catalyst layer at substantially the same level along the length of the fuel channel. Anisotropic GDLs find particular use in direct exhaust fuel cells, i.e., non-recirculating fuel cells in which the exhaust from the anode side of the fuel cell is directly exhausted and not recirculated to the anode inlet. See FIGS. 1, 3 and 4.

In the case of recirculating fuel cells, e.g., a fuel cell with an anode loop, an anisotropic GDL can be used but it is less beneficial than with non-recirculating fuel cells. This is because excess methanol exiting the anode is reintroduced into the anode chamber for subsequent oxidation thus the relative change in concentration of the methanol over the surface is less than that of a non-recirculated fuel cell.

However, in either case, the cathode GDL having reduced water diffusivity is necessary if insufficient water is present in the fuel to maintain humidification of the PEM and, if required, to support the anode reaction. In the case of methanol, this occurs when there is less than 50 mole % of water in the methanol fuel. In practicing this aspect of the invention, the amount of water in the methanol fuel on a mole-to-mole basis is preferably 0-50%, 2-50%, 5-50% or 10-50%.

The system preferably further comprises a fuel injection assembly. The fuel injection assembly is a positive flow device, such as a piezo-electric pump, and its associated fluid connectors and control signals, which direct a controlled amount of fuel from the fuel source to the fuel inlet ports which itself may be part of a fluid recirculation path. Fuel injection assemblies are in fluid communication with the fuel inlet port(s) and adapted to be in fluid communication with liquid fuel from a fuel source. The fuel injection assembly may facilitate the vaporization of all or part of the liquid fuel typically by being in thermal contact with the fuel cell itself to enable the flow of waste heat from the electrochemical reaction within the fuel cell to the liquid fuel passing through the fuel injection assembly. This causes a portion or all of the fuel to vaporize prior to entering the fuel inlet port(s) of the fuel cell. In the case of most liquid fuels, such as methanol, vaporization is an endothermic process. Accordingly, a heat source facilitates vaporization. In some cases, the heat source may be a heating element which may be part of the fuel injection assembly. In other cases, it can be the waste heat from fuel oxidation within the fuel cell system which can be directed to the fuel injection assembly through direct thermal contact with the fuel cell or by heat energy contained in the cathode exhaust stream by using a vaporizer heat exchange module. These can be used in conjunction with a heating element, i.e, the heating element would be used during start-up of the fuel cell system when the electrochemical waste heat is preferably utilized to heat the fuel cell itself. A fuel concentration sensor, such as a methanol sensor, can be placed in fluid communication with the exhaust port(s) of the fuel cell assembly. The sensor is used as a control signal to meter the flow of methanol by the fuel injection assembly into the fuel loop so as to maintain sufficient methanol in the fuel cell to support the electrochemical reaction and minimize the amount of methanol lost in the exhaust in a non-recirculating fuel cell system. The fuel injection assembly can be used with a single fuel cell or a fuel cell stack.

The fuel injection assembly is adapted to be in fluid communication with a fuel source such as a tank or cartridge. When an anode loop is used, it comprises the fuel flow field(s) and a conduit(s) having a first end in fluid communication with the exhaust port(s) of the flow field and a second end in direct or indirect fluid communication with the fuel inlet port(s). The anode loop further comprises a vent between the first and second ends of the loop to vent gases such as CO₂ from the anode loop. The vent can be a valve, pressure relief valve, check valve, orifice or carbon dioxide permeable membrane. The fuel cell system can also comprise a fuel recirculation pump in fluid communication with the anode loop. The pump can be a miniature centrifugal blower, a flexible impeller pump or one of the several variations of diaphragm pumps. Those include, but are not limited to, electric motor driven pumps, voice coil driven pumps and piezoelectric actuated pumps.

The fuel cell system can also include a fuel delivery assembly for a fuel cell stack comprising a plurality of anode plates that form a plurality of fuel cell assemblies each having a fuel flow field. A fuel stack header is in fluid communication with each of the fuel flow fields and a flow limiter is positioned between the fuel stack header and each of the fuel flow fields. The flow limiter(s) are configured to provide substantially equal flow distribution of fuel into each of the cells in the fuel flow fields.

In the design of fuel cells, it is highly advantageous to make certain that the distribution of reactant is uniform in the fuel flow field or among the fuel flow fields in a stack of cells. Droplets of water and/or methanol that can form in the anode compartment of each fuel cell will cause the reactant distribution to become less uniform. One approach to lessen the impact of water droplets in a cell is to design the cell with sufficient pressure loss along the passages so that droplets will continue to move when they form. However, the energy required to generate such a pressure loss can represent a significant parasitic load to the fuel cell system. Hydrophilic treatment (e.g., treatments which leave the surface with chemisorbed oxygen complexes which improve the “wetting” characteristics of the surface), of the anode GDL, anode flow field plate, or both, causes the droplets on the surfaces of the passageways to be wicked flat and have a reduced impact on the distribution of flow among the cells. A correspondingly lower pressure drop is required by the recirculation pump, leading to a lower parasitic load and higher overall system efficiency.

Using one or more of the approaches described above in a vapor phase DMFC fuel cell system allows significant simplification of the balance of plant. For example, because the cathode GDL allows water produced the cathode to humidify the PEM and, if required, to diffuse to the anode via the PEM, the following system components can be eliminated: (1) the condenser or other water knock-out devices typically used to collect product water from the cathode exhaust; (2) means for directing such water collected from the cathode exhaust back to the anode which are typically external to the fuel cell itself, such as pumps, reservoirs and associated sensors and controllers; and (3) heat exchangers for rejecting waste heat from the fuel cell and waste heat from the condensation of water vapor for water recovery from the cathode for use in the anode reaction.

Furthermore, if one or more of the approaches described above are used, then the DMFC fuel cell system does not require separate devices for supplying cooling air and reactant air. The reactant air supply does not need sufficient pressure to force water droplets out of the fuel cell assembly, and a common, low pressure, low parasitic load (power) air delivery device can be used for both reactant air supply and air-cooling. A separate radiator is not required for cooling. The fuel cell stack itself can be designed to remove waste heat via the oxidant air channels.

Thus, implementation of one or more aspects of the invention leads to a more compact system with lower parasitic losses and reduced system cost and complexity

V. PEMs

Any or all of the components can be used in a fuel cell. A preferred fuel cell is a direct methanol fuel cell where the fuel is liquid methanol that contains little of any matter. Such a fuel cell is operated with vaporized methanol at the anode.

Any ion-conductive polymer can be used to make the PEM used in the invention. Particularly preferred polymers include the following.

An ion-conductive copolymers useful in practicing the invention may be represented by Formula I:
[[Ar₁-T-)ᵢ-Ar₁-X-]ₐ^{m}[Ar₂-U-Ar₂-X-]_{b}ⁿ[(Ar₃-V-)ⱼ-Ar₃-X-]_{c}^{o}[Ar₄-W-Ar₄-X-]_{d}^{p}] Formula I

wherein Ar₁, Ar₂, Ar₃ and Ar₄ are aromatic moieties, where at least one of Ar1 comprises an in conducting group and where at least one of Ar₂ comprises an ion-conducting group;

T, U, V and W are linking moieties;

X are independently —O— or —S—;

i and j are independently integers equal to or greater than 1;

a, b, c, and d are mole fractions wherein the sum of a, b, c and d is 1, a is at least 0.3 and at least one of b, c and d are greater than 0; and

m, n, o, and p are integers indicating the number of different oligomers or monomers in the copolymer.

An ion conducting copolymer useful in practicing the invention may also be represented by Formula II:
[[Ar₁-T-)ᵢ-Ar₁-X-]ₐ^{m}[Ar₂-U-Ar₂-X-]_{b}ⁿ[(Ar₃-V-)ⱼ-Ar₃-X-]_{c}^{o}[Ar₄-W-Ar₄-X-]_{d}^{p}] Formula II

wherein

Ar₁, Ar₂, Ar₃ and Ar₄ are independently phenyl, substituted phenyl, napthyl, terphenyl, aryl nitrile and substituted aryl nitrile;

at least one of Ar₁ comprises an ion-conducting group; at least one of Ar₂ comprises an ion-conducting group;

T, U, V and W are independently a bond, —O—, —S—, —C(O)—, —S(O)₂—,

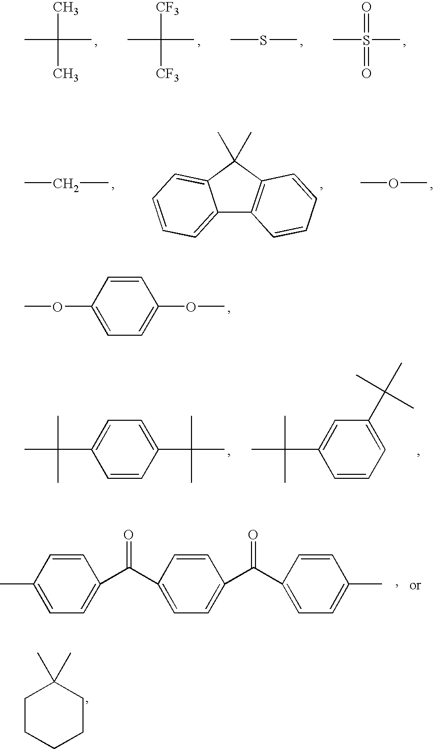

X are independently —O— or —S—;

i and j are independently integers equal to or greater than 1; and

a, b, c, and d are mole fractions wherein the sum of a, b c and d is 1, a is at least 0.3 and at least one of b, c and d are greater than 0; and

m, n, o, and p are integers indicating the number of different oligomers or monomers in the copolymer.

R₁ and R₂ are end capping monomers where at least one of R₁ and R₂ is present in said copolymer.

An ion-conductive copolymer useful in practicing the invention can also be represented by Formula III:
[[Ar₁-T-)ᵢ-Ar₁-X-]ₐ^{m}[Ar₂-U-Ar₂-X-]_{b}^{a}[(Ar₃-V-)ⱼ-Ar₃-X-]_{c}^{o}[Ar₄-W-Ar₄-X-]_{d}ⁿ] Formula III

wherein

Ar₁, Ar₂, Ar₃ and Ar₄ are independently phenyl, substituted phenyl, napthyl, terphenyl, aryl nitrile and substituted aryl nitrile;

at least one of Ar1 comprises an ion-conducting group;

at least one of Ar2 comprises an ion-conducting group;

where T, U, V and W are independently a bond O, S, C(O), S(O₂), alkyl, branched alkyl, fluoroalkyl, branched fluoroalkyl, cycloalkyl, aryl, substituted aryl or heterocycle;

X are independently —O— or —S—;

i and j are independently integers equal to or greater than 1;

a, b, c, and d are mole fractions wherein the sum of a, b, c and d is 1, a is at least 0.3 and at least one of b, c and d are greater than 0; and

m, n, o, and p are integers indicating the number of different oligomers or monomers in the ion conducting copolymer.

In preferred embodiments, at least two of b, c and d are greater than 0. In some embodiments, c and d are greater than 0. In other embodiments, b and d are greater than 0. In still another embodiment, b and c are greater than 0. In other embodiments each of b, c and d are greater than 0.

The ion conductive copolymers that can be used in the invention include the random copolymers disclosed in U.S. patent application Ser. No. 10/438,186, filed May 13, 2003, entitled “Sulfonated Copolymer,” Publication No. US 2004-0039148 A1, published Feb. 26, 2004, and U.S. patent application Ser. No. 10/987,178, filed Nov. 12, 2004, entitled “Ion Conductive Random Copolymer” and the block copolymers disclosed in U.S. patent application Ser. No. 10/438,299, filed May 13, 2003, entitled “Sulfonated Copolymers,” published Jul. 1, 2004, Publication No. 2004-0126666. Other ion conductive copolymers include the oligomeric ion conducting polymers disclosed in U.S. patent application Ser. No. 10/987,951, filed Nov. 12, 2004, entitled “Ion Conductive Copolymers Containing One or More Hydrophobic Monomers or Oligomers,” U.S. patent application Ser. No. 10/988,187, filed Nov. 11, 2004, entitled “Ion Conductive Copolymers Containing First and Second Hydrophobic Oligomers” and U.S. patent application Ser. No. 11/077,994, filed Mar. 11, 2005, entitled “Ion Conductive Copolymers Containing One or More Ion Conducting Oligomers.” All of the foregoing are incorporated herein by reference. Other ion conductive copolymers include U.S. Patent Application No. 60/684,412, filed May 24, 2005, entitled “Ion Conductive Copolymers Containing Ion-Conducting Oligomers,” U.S. Patent Application No. 60/685,300, filed May 27, 2005, entitled “End Capping of Ion-Conductive Copolymers,” U.S. Patent Application No. 60/686,757, filed Jun. 1, 2005, entitled “Cross-Linked Ion-Conductive Copolymers,” U.S. Patent Application No. 60/686,663, filed Jun. 1, 2005, entitled “Polymer Blend Comprising Ion Conductive Polymer and Non-Conductive Polymers,” U.S. Patent Application No. 60/686,755, filed Jun. 1, 2005, entitled “Ion-Conductive Copolymers Containing Pendant Ion Conducting Groups,” and U.S. Patent Application No. 60/687,408, filed Jun. 2, 2005, entitled “Anisotropic Polymer Electrolyte Membranes.”

Other ion-conducting copolymers and the monomers that can be used to make them include those disclosed in U.S. patent application Ser. No. 09/872,770, filed Jun. 1, 2001, Publication No. US 2002-0127454 A1, published Sep. 12, 2002, U.S. patent application Ser. No. 10/351,257, filed Jan. 23, 2003, Publication No. US 2003-0219640 A1, published Nov. 27, 2003, U.S. application Ser. No. 10/449,299, filed Feb. 20, 2003, Publication No. US 2003-0208038 A1, published Nov. 6, 2003, each of which are expressly incorporated herein by reference. Other ion-conducting copolymers that can be end capped are made for comonomers such as those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35:1348 (2002)); polyimides (U.S. Pat. No. 6,586,561 and J. Membr. Sci. 160:127 (1999)) and Japanese Patent Applications Nos. JP2003147076 and JP2003055457, each of which are expressly identified herein by reference.

Although the ion conductive copolymers that can be used to practice the invention have been described in connection with the use of arylene ether or sulfide polymers, ion conductive polymers that can be used to practice the invention may contain aliphatic or perfluorinated aliphatic backbones (e.g. Nafion), or contain polyphenylene, polyamide or polybenzimidazole backbones. Ion-conducting groups may be attached to the backbone or may be pendant to the backbone, e.g., attached to the polymer backbone via a linker. Alternatively, ion-conducting groups can be formed as part of the standard backbone of the polymer. See, e.g., U.S. 2002/018737781, published Dec. 12, 2002 incorporated herein by reference. Any of these ion-conducting oligomers can be used to practice the invention.

The following are some of the monomers used to make ion-conductive copolymers.

1) Difluoro-End Monomers

| | | Molecular | |
|---|---|---|---|
| Acronym | Full name | weight | Chemical structure |
| Bis K | 4,4′-Difluorobenzophenone | 218.20 | 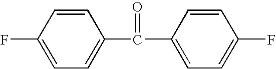 |
| Bis SO₂ | 4,4′-Difluorodiphenylsulfone | 254.25 | 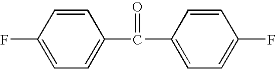 |
| S-Bis K | 3,3′-disulfonated-4,4′- difluorobenzophone | 422.28 | 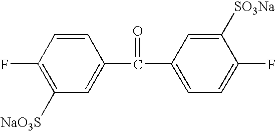 |

2) Dihydroxy-End Monomers

| | | | |
|---|---|---|---|
| Bis AF (AF or 6F) | 2,2-Bis(4-hydroxyphenyl) hexafluoropropane or 4,4′-(hexafluoroisopropylidene) diphenol | 336.24 | 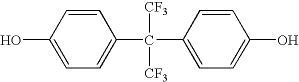 |
| BP | Biphenol | 186.21 | 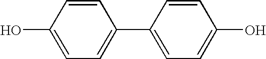 |
| Bis FL | 9,9-Bis(4-hydroxyphenyl)fluorene | 350.41 | 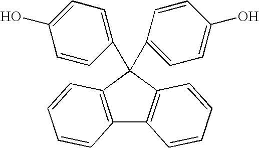 |
| Bis Z | 4,4′-cyclohexylidenebisphenol | 268.36 | 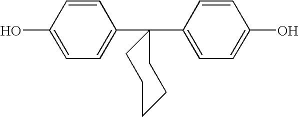 |
| Bis S | 4,4′-thiodiphenol | 218.27 | 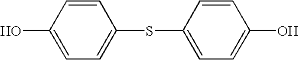 |

3) Dithiol-End Monomers

| | Full | Molecular | |
|---|---|---|---|
| Acronym | name | weight | Chemical Structure |
| | 4,4-thiol bis benzene thiol | | 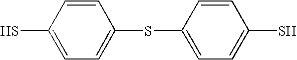 |

A preferred ion-conductive random copolymer for use in a direct methanol fuel cell has the following formula 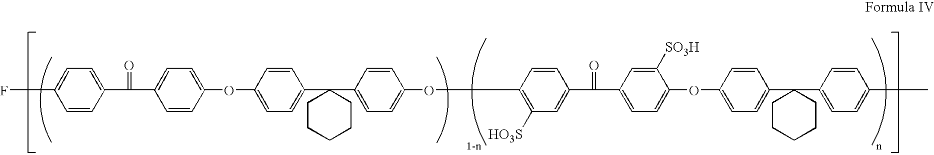
where n is from 0.10 to 0.45

The mole percent of ion-conducting groups when only one ion-conducting group is present in comonomer I is preferably between 30 and 70%, or more preferably between 40 and 60%, and most preferably between 45 and 55%. When more than one conducting group is contained within the ion-conducting monomer, such percentages are multiplied by the total number of ion-conducting groups per monomer. Thus, in the case of a monomer comprising two sulfonic acid groups, the preferred sulfonation is 60 to 140%, more preferably 80 to 120% and most preferably 90 to 110%. Alternatively, the amount of ion-conducting group can be measured by the ion exchange capacity (IEC). By way of comparison, Nafion® typically has a ion exchange capacity of 0.9 meq per gram. In the present invention, it is preferred that the IEC be between 0.9 and 3.0 meq per gram, more preferably between 1.0 and 2.5 meq per gram, and most preferably between 1.6 and 2.2 meq per gram. In a preferred embodiment, a is 0.7 and b is 0.3.

Polymer membranes may be fabricated by solution casting of the ion-conductive copolymer. Alternatively, the polymer membrane may be fabricated by solution casting the ion-conducting polymer the blend of the acid and basic polymer.

When cast into a membrane for use in a fuel cell, it is preferred that the membrane thickness be between 0.1 to 10 mils, more preferably between 0.25 and 6 mils, most preferably less than 2.5 mils, and it can be coated over polymer substrate.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion membrane of the same thickness. In preferred embodiments the permeability of methanol is preferably 50% less than that of a Nafion membrane, more preferably 75% less and most preferably greater than 80% less as compared to the Nafion membrane. If the membrane is designed for use in hydrogen fueled fuel cell, this methanol permeability feature is irrelevant.

After the ion-conducting copolymer has been formed into a membrane, it may be used to produce a catalyst coated membrane (CCM). As used herein, a CCM comprises a PEM when at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum is generally applied on the anode and cathode sides. Catalysts may be optionally supported on carbon on either or both sides. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

The CCM is used to make MEA's. As used herein, an MEA refers to an ion-conducting polymer membrane made from a CCM according to the invention in combination with anode and cathode GDL's positioned to be in electrical contact with the catalyst layer of the CCM. The anode GDL us preferably an anisotropic GDL.

An alternative method to make an MEA is to use gas diffusion material onto which one surface has a coating of catalyst as described above, and such gas diffusion materials are affixed to the membrane with the catalyst coated surface in contact with said membrane on either side to form both a cathode and anode side, thereby creating an MEA.

Electrodes are in electrical contact with the catalyst layer, either directly or indirectly, when they are capable of completing an electrical circuit which includes the MEA and a load to which the fuel cell current is supplied. More particularly, a first catalyst is electrocatalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the cathode to the load and then to the anode. Balancing this direct electron current is the transfer of an equivalent number of protons across the membrane to the anodic compartment. There an electrocatalytic reduction of oxygen in the presence of the transmitted protons occurs to form water. In one embodiment, air is the source of oxygen. In another embodiment, oxygen-enriched air is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output. Such applications include electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

Such CCM and MEA's are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The CCM's and MEA's of the invention may also be used in hydrogen fuel cells that are known in the art. Examples include U.S. Pat. Nos. 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

### EXAMPLES

### Example 1

### Non-Recirculated

This example discloses a system for use with pure liquid fuel (methanol) directly into a fuel cell with very low fuel stoichiometry where product water is transported from the cathode through the membrane to the anode. A system diagram is shown in FIG. 1.

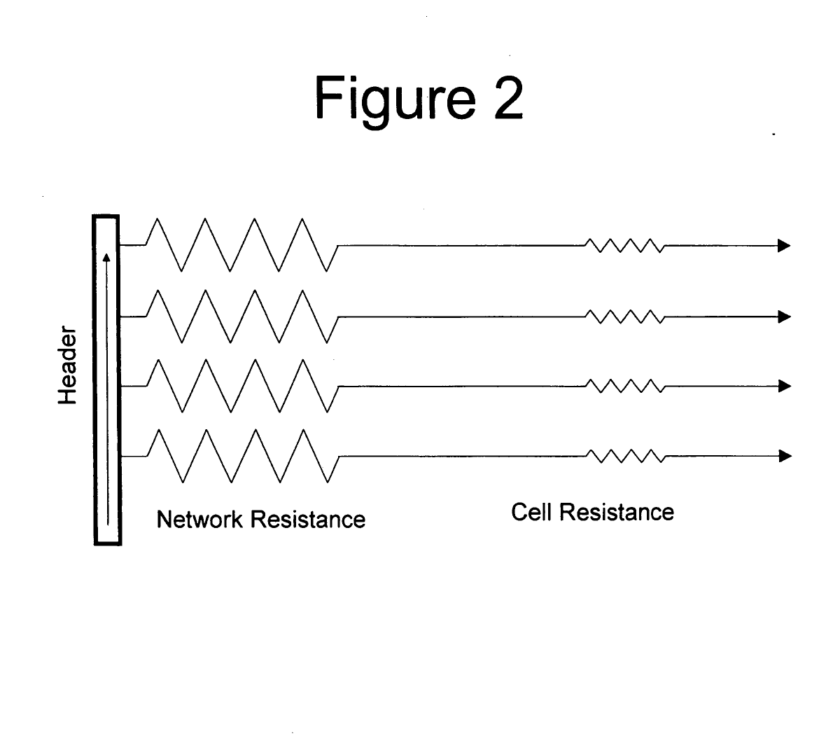

Pure methanol (or very high concentration methanol with some added water) is delivered to the fuel cell stack. The methanol, still in the liquid phase, is then directed through a precise flow splitter that delivers the same amount of fuel (to within less than 5%) to each cell. The flow splitter works on the basis of pressure drop. An example of such a splitter would be an orifice. There is a relatively large, precisely controlled pressure drop in each leg of the flow splitter compared with the low, imprecisely controlled pressure drop in the fuel cell fluid passages. The large pressure drop of the flow splitter is between 5 and 50 times the pressure drop of the fuel cell flow channels, preferably greater than 10 times. See FIG. 2.

The fuel is evaporated directly inside the fuel cell passages whereby the fuel now is in the vapor state. This phase change is endothermic and utilizes some of the waste heat of the electrochemical reaction to effect the methanol phase change from liquid to vapor. Distribution of the liquid fuel into each cell is done in a manner such that there is good heat transfer from the electrochemical reaction areas to this area to effect the fuel phase change for any fuel which is not already in the gaseous state.

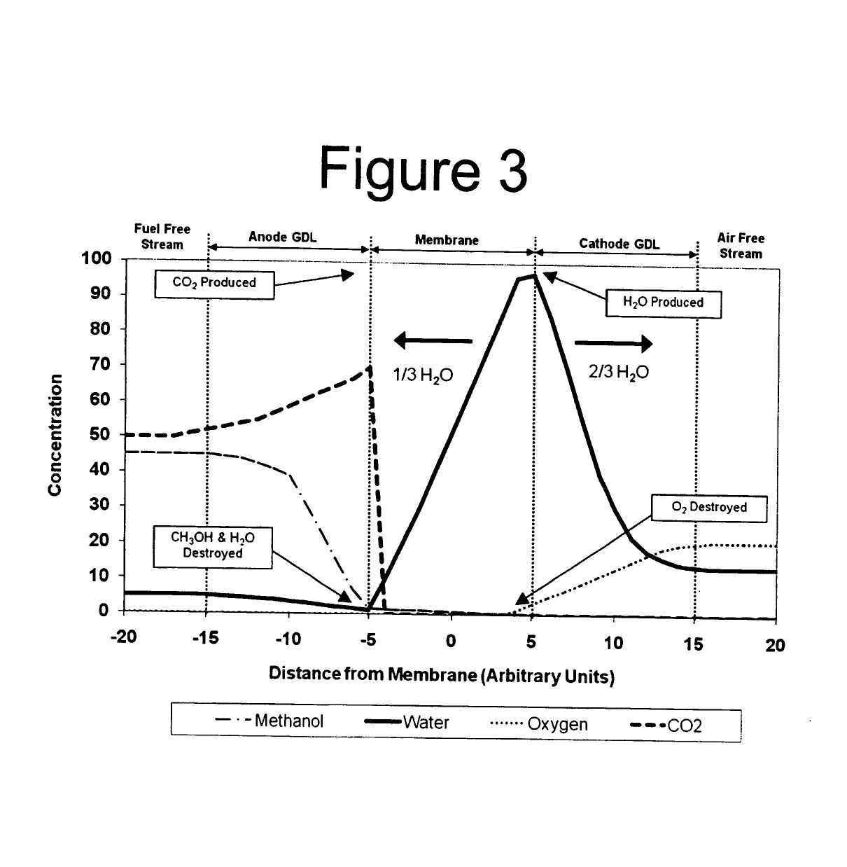

When the cell is running, the flux of methanol from the channel to the anode catalyst results in a drop in concentration due to diffusion through the porous GDL. This effect, as well as the gradients resulting from water and oxygen transport, is shown in FIG. 3.

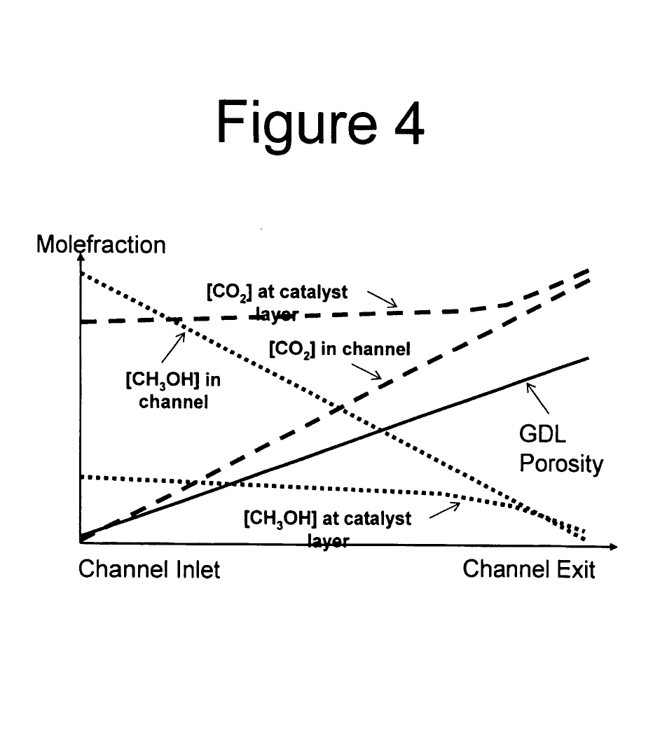

If the liquid methanol is evaporated at the anode channel inlet, it will result in a zone that is saturated with methanol vapor in that location. Evaporation of the injected methanol, and generation of CO₂ creates a convective flow of gas and vapor towards the channel exit. Along the length of the anode channel, as methanol is consumed it is replaced on a one to one molar basis by CO₂. Thus the methanol vapor concentration in the channel drops along the channel length. If the methanol injection rate is near stoichiometry 1, the methanol vapor concentration in the channel will approach zero at the channel exit. To account for the variation in channel concentration, and to maintain a uniform, low methanol concentration at the anode catalyst, the anode GDL porosity is varied along the channel length, increasing towards the exit as shown in FIG. 4.

The rate of fuel injected by the fuel feed pump or feed valve into the fuel cell is metered using a control signal of the amount of methanol vapor detected in the fuel cell anode exhaust by the methanol concentration sensor. The feed rate is adjusted to hold the methanol concentration at a fixed level in the exhaust and to provide sufficient methanol for the electrochemical reaction. The anode exhaust methanol concentration is intended to be very low to keep overall methanol emissions down and fuel efficiency up.

The fuel exhaust may contain methanol vapor which may be further reduced in concentration through one or more of the following:
1. The fuel exhaust is diluted with the cooling air to exit the fuel cell system at a concentration below acceptable emissions levels as defined by regulations and/or safety standards.
2. The fuel exhaust is sent back through the cathode passages where a substantial portion of the remaining methanol is directly oxidized on the cathode catalyst and the resulting cathode exhaust stream has fuel concentration below acceptable emissions levels.
3. The fuel exhaust is fed into another cell or series of cells to consume most of the remaining fuel. The voltage(s) of the cell(s) can then be used to indirectly determine the methanol concentration in the exhaust. There is no need for an additional methanol sensor.
4. The fuel exhaust is mixed with air and run past a separate catalyst filled volume to directly oxidize most of the remaining methanol.

The air flow on the cathode serves two primary functions: providing oxygen to the cathode electrode of the fuel cell and removing waste heat from the fuel cell. The flow rate of air is set to control the cell temperature and this is more than enough to provide sufficient oxygen for cell operation. In cases where the fuel cell is cold, i.e., when it first starts up, the flow rate of air may be set to a minimum flow rate which provides sufficient oxygen for the reaction and for dilution for any fuel which it might contain. In order to retain sufficient water on the cathode to both humidify the membrane and provide water for the anode reaction, the rate of diffusion out of the cathode is controlled by the porosity of the cathode GDL structure. The GDL structure is engineered such that the concentration of water is near 100% RH at the operating temperature at the cathode GDL/membrane interface (shown in FIG. 3) with ⅔ of the product water leaving the cathode free air stream exit. The remaining ⅓ of the product water diffuses back across the PEM to the anode, humidifying the PEM and to participate in the anode methanol oxidation reaction.

This significantly simplifies the balance of plant for a DMFC system by eliminating the air compressor, the condenser, and the intermediate low concentration water tank of conventional DMFC systems. The improvements lead to a more compact system with lower parasitic losses and reduced system cost and complexity. The elimination of the air compressor significantly reduces the noise of the system as there are no remaining acoustically loud elements.

A separate radiator is not required for cooling. The fuel cell stack itself is designed to have high heat removal in the air channels.

The system configuration also eliminates the problem of orientation sensitivity. Most DMFC systems that have significant liquid tanks and liquid-gas separators can operate in only a narrow range of orientations. The proposed system with only vapor in the system should be able to operate without a preferred orientation.

Fuel cells of the invention can be used over a wide range of DMFC power levels, but are best suited to those in the 5-500 Watt range with no extreme temperature requirements. This is the range for a large number of portable electronics equipment, particularly laptop computers.

### Example 2

The following discloses a system that feeds vapor methanol into a fuel cell system with anode re-circulation. One embodiment is shown in FIG. 5.

There are two fluid flows in the system: fuel flow on the anode and air flow on the cathode. The fuel is injected from the fuel tank into the vaporizer and then mixed with the re-circulated flow. The diluted fuel is fed into the fuel cell anode compartment where water produced at the cathode diffuses through the MEA to the anode. The anode reaction proceeds according to the following: CH₃OH+H₂O→CO₂+6H⁺+6e⁻. The protons then proceed from the anode to the cathode through the Polymer Electrolyte Membrane (PEM). The exhaust from the fuel cell anode is recycled by a small recycle pump back to the fuel vaporizer via a membrane separation device that is designed to preferentially release CO₂ in the gas stream. The membrane in the separator is designed to release sufficient CO₂, and some portion of the nitrogen (which diffuses across the PEM from the cathode) while retaining as much methanol and water as possible. Alternatively, a pressure valve can be used to vent the anode exhaust gas. The former is preferred as it results in a decrease in methanol transfer from the system. The preferable recirculation rate on the anode is such that the fuel stoichiometry is greater than 1, but less than 10. The relatively low recirculation has two advantages: lower methanol concentration at the CO₂ separator (less escaping methanol) and a lower parasitic loss in the recirculation compressor.

The anode vent exhaust, shown in FIG. 5. as the CO₂ vent, may contain methanol vapor which may be further reduced in concentration through one or more of the following:
1. The anode vent exhaust is diluted with the cooling air to exit the fuel cell system at a concentration below acceptable emissions levels as defined by regulations and/or safety standards.
2. The anode vent exhaust is sent back through the cathode passages where a substantial portion of the remaining methanol is directly oxidized on the cathode catalyst and the resulting cathode exhaust stream has fuel concentration below acceptable emissions levels.
3. The anode vent exhaust is fed into another cell or series of cells to consume most of the remaining fuel. The voltage(s) of the cell(s) can then be used to indirectly determine the methanol concentration in the exhaust. There is no need for an additional methanol sensor.
4. The anode vent exhaust is mixed with air and run past a separate catalyst filled volume to directly oxidize most of the remaining methanol.

The rate of fuel injected by the fuel feed pump or feed valve into the vaporizer can be modulated by a variety of strategies. The amount of methanol vapor detected in the anode exhaust by the methanol concentration sensor can be use as a feedback, with the feed rate is adjusted to hold the methanol concentration at a fixed level in the anode exhaust. Alternatively, the cell voltage can be used along with other data such as the current pump flowrate to adjust the methanol feed rate.

Conventional DMFC systems reduce the methanol concentration at the anode electrode by diluting the feed methanol with water. The gaseous system as disclosed herein uses a dilution concept as well, but employs nitrogen and carbon dioxide gas to dilute methanol gas instead of liquid water to dilute liquid methanol to achieve a similar effect.

An added feature on the anode compartment is a grading of the GDL porosity. The GDL is much less porous near the inlet where the methanol concentration is high, but much more porous near the exit where the methanol concentration in low. The grading of the porosity is less useful as the recirculation rate of the fuel exhaust is increased.

FIG. 5 shows the fuel vaporizer as a fully separate entity for simplicity and clarity. In a real system the vaporizer would be closely coupled to the fuel cell stack itself to best transfer heat from the fuel cell to the vaporizer section. In fact, it may be possible for the liquid to vaporize directly inside the fuel cell itself. A separate heating element may form part of the vaporizer, such heating element could be powered by energy from the fuel cell or from a separate energy source such as a battery, to provide thermal energy to vaporize liquid fuel. A heating element could be used during start-up, when it is preferred to use the waste thermal energy from the fuel cell electrochemical reaction to heat the fuel cell itself, or in combination with thermal energy from the fuel cell stack.

The air flow on the cathode serves two functions: providing oxygen to the cathode electrode of the fuel cell and removing waste heat from the fuel cell. The flow rate of air is set to control the cell temperature and this is more than enough to provide sufficient oxygen for cell operation. In order to retain sufficient water on the cathode to both humidify the membrane and provide water for the anode reaction, the rate of diffusion out of the cathode is controlled by the porosity of the cathode GDL structure. The GDL structure is engineered such that the concentration of water is near 100% RH at the cathode catalyst to PEM interface at the operating temperature and pressure of the cathode with ⅔ of the product water leaving the cathode exit. The remaining ⅓ of the product water diffuses back across the membrane to the anode.

The system simplifies the balance of plant for a DMFC system by eliminating the air compressor, the condenser, and the intermediate low concentration water tank of conventional DMFC systems. This results in a more compact system with lower parasitic losses and reduced system cost and complexity. The elimination of the air compressor should significantly reduce the noise of the system, although the small fuel gas recirculation pump may reduce some of the noise advantage of the concept. In addition, no separate radiator is required for cooling. The fuel cell stack itself is designed to have high heat removal via the air passages.

The system configuration also eliminates the problem of orientation sensitivity. Most DMFC systems that have significant liquid tanks (in addition to the fuel source tank or cartridge) and liquid-gas separators that can operate in only a limited range of orientations. The system with only vapor in the system should be able to operate without a preferred orientation.

### Example 3

The following is directed to the uniform distribution of fuel to the cells in a fuel cell stack, in an open loop system. The expected pressure drop of each anode flowfield is small, and the intent is to keep the fuel stoichiometry just above 1.0, but with only a small variation from cell to cell, so no cell is fuel starved, and no cell has a considerable excess of fuel.

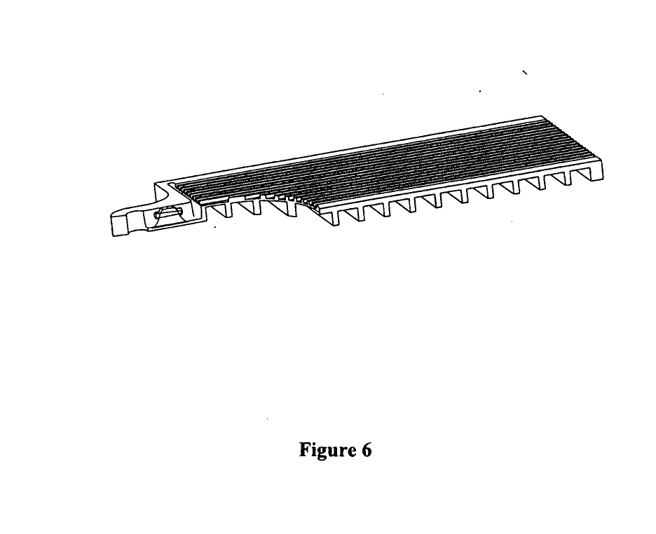

FIG. 6 is a section plate showing a fuel limiter 10 in plotting resin 20. A fuel cell header 30 is in fluid communication with fuel channels 40. Air channels 50 are on the opposing surface of the plate and are perpendicular to the fuel channels 40.

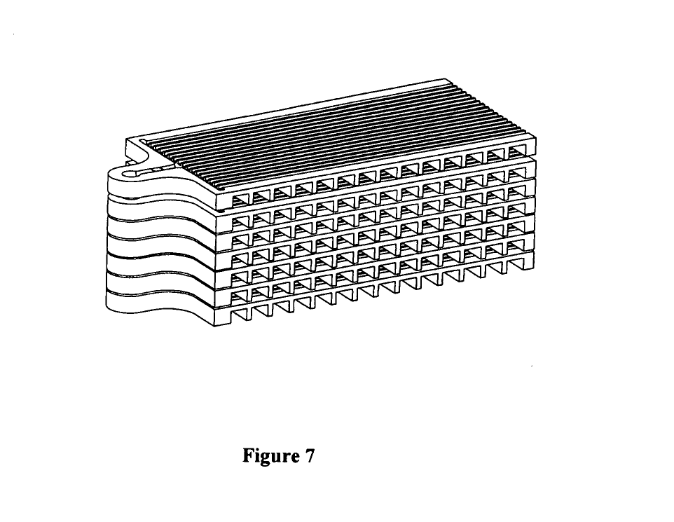

FIG. 7 is a fuel cell stack made of the plates of FIG. 6. The fuel is introduced to the stack via a stack header 60 where it is metered through the flow limiters 10 in the individual plates to cell header 30 (not shown) and into fuel channels 40.

A porous flow limiter, made of a ceramic or other stable material, that can be post machined to achieve a desired flow rate. The component has a non-porous surface, and a porous core, so that the effective flow resistance is a function of the cut length. This post machining could be just after cutting to length, or after bonding into flowfields. If the post machining is done after bonding, it would also serve as a leak test of the fuel supply side of the fuel cell plate. The pressure drop through the limiter would be many times the pressure drop through a flow field, so that the total pressure drop for the fuel side becomes defined by the limiters. The restrictor pressure drop can range from 5 to 100 times the total drop of the anode plates, but would typically be from 5 to 15 times the pressure drop of the anode side. This way, the difference between a dry anode MEA and flow field, and a very moist anode and flow field is insignificant, so that the reactant distribution can not be affected by differences in the anode environment. Further, the limiters are upstream, so that differences in the anode environment can not affect the flow from the anode fields to ambient. Such porous flow limiters operate best with single phase fuel at the fuel inlet.

The flow limiter also serves as a bridge so that an additional cell component that is specifically a bridge is not needed. In operation, the distribution channel is filled with liquid, and the pressure changed to force the liquid through the metering limiters. The distribution channel has enough thermal isolation from the stack that vaporization of the fuel does not occur. Rather, the fuel vaporizes downstream of the limiters, as it moves into the individual cell flowfield. The fuel pressure can be a linearly controlled value, or a PWM (Pulse Width Modulated) fuel supply, with a measured pulse having a frequency sufficient enough that the fuel supply in the flowfields is effectively constant, over the range of current the stack supplies.

### Example 4

A humidified vapor flow stream was created in the test station and run through the anode in a single pass, and then vented. This tests the performance of the fuel cell under known anode vapor conditions. A small reduction in performance is incurred, but this is acceptable due to potential savings at the system level.

### Example 5

Again in a flow-through configuration, this data shows the performance of a vapor DMFC depending on the fuel vapor concentration. Such data is important since the vapor fuel concentration is an important system parameter.

### Example 6

This fuel cell was run in a recirculated vapor configuration, where the CO₂ gas, nitrogen gas, H₂O vapor, and methanol vapor were recirculated in an anode loop by a small pump. Only pure liquid methanol is metered into the loop at a controlled stoichiometry, and quickly vaporizes. The anode is run at a constant pressure conditions, so that excess CO₂ is vented as it is produced. This configuration is compatible with compact, stand-alone systems.

What is claimed is:

1. A method of operating a fuel cell system comprising a fuel cell assembly comprising:
an anode comprising a catalyst layer, a fuel entry port, a fuel flow field in fluid communication with said anode, and a fuel exhaust port;
a cathode comprising a catalyst layer, an oxidant entry port, an oxidant flow field in fluid communication with said cathode, and an oxidant exhaust port;
a polymer electrolyte membrane interposed between said anode and said cathode; and
an anode recirculation loop in fluid communication with said fuel exhaust port and said fuel inlet port;
wherein said method comprises:
(i) directing an oxidant stream to at least one said fuel cell cathode via said oxidant entry port;
(ii) directing gaseous methanol to a least one said fuel cell anode via said fuel entry port;
(iii) operating said fuel cell assembly so that water is produced at said cathode and carbon dioxide is produced at said anode; and
(iv) recirculating a the gaseous anode exhaust stream in said anode recirculation loop.

2. The method of claim 1 wherein the concentration of methanol in said recirculated gaseous anode exhaust stream is less than about 10 volume %.

3. The method of claim 1 where in the concentration of methanol in said recirculated gaseous anode exhaust stream is less than about 5 volume %.

4. The method of claim 1 further comprising venting at least a portion of said anode exhaust stream containing carbon dioxide during said recirculating.

5. The method of claim 4 wherein such venting is by a carbon dioxide separator or vent in fluid communication with said anode loop.

6. The method of claim 4 wherein said venting is by a pressure relief valve which is in fluid communication with said anode loop.

7. The method of claim 1 further comprising directing all or a portion of the water produced at said cathode to said anode by diffusion of such water through the polymer electrolyte membrane induced by a concentration gradient of water across said membrane.

8. The method of claim 7 where said cathode further comprises a cathode GDL having a through-plane water diffusivity that causes said directing of said water to and across said PEM.

9. A method of operating a fuel cell system comprising at least one fuel cell assembly and a liquid methanol fuel supply, said method comprising
(a) vaporizing methanol from said liquid methanol fuel supply using waste heat from at least one said fuel cell assembly to form methanol gas;
(b) directing said methanol gas to at least one said fuel cell assembly.

10. A method of operating a gas phase direct methanol fuel cell system comprising at least one fuel cell assembly, each assembly comprising an anode, a cathode and a polymer electrolyte membrane (PEM), the method comprising electrochemically oxidizing methanol at said anode, wherein the system is operated such that the primary source of water at said fuel cell anode is water produced at said cathode that diffuses through said PEM in an amount sufficient to humidify said PEM and provide water for the anode methanol oxidation reaction.

11. A gas phase fuel cell system comprising:
(a) a fuel cell assembly comprising an MEA disposed between first and second fuel cell plates, wherein at least said first plate and the anode surface of said MEA define a fuel flow field having a fuel entry port and an exhaust port, and wherein said MEA comprises an anode GDL; a cathode GDL; a polymer electrolyte membrane (PEM) disposed between said anode GDL and said cathode GDL; an anode catalyst layer interposed between said anode GDL and said PEM, and a cathode catalyst layer interposed between said cathode GDL and said PEM; and
(b) an anode gas recirculation loop comprising (i) said fuel flow field(s), (ii) a conduit having a first end in fluid communication with the exhaust port(s), and a second end in fluid communication with said fuel entry port(s); and (iii) a vent between said first and second ends to vent gases from the anode loop.

12. The fuel cell system of claim 11 wherein when operating, waste heat from the electrochemical reaction within the fuel cell system facilitates vaporization of at least a portion of a liquid fuel to a gas.

13. The fuel cell system of claim 11 wherein said cathode GDL has restricted diffusivity to water so that when said MEA is used in an operating methanol gas phase fuel cell at least a portion of the water produced at the cathode diffuses across said PEM to the anode in an amount sufficient to humidify the PEM and provide water for the anode reaction.

14. The fuel cell system of claim 13 wherein about one-third of the water produced at the cathode diffuses to the anode.

15. The fuel cell system of claim 11 further confirming an anisotropic gas diffusion layer (GDL).

16. The fuel cell system of claim 15 wherein said anisotropic GDL comprises a plurality of gas diffusion pores in a first layer of conductive non-metallic material, wherein said first layer has increased gas diffusivity in at least a first direction.

17. The fuel cell system of claim 12 wherein said fuel is methanol.

18. The fuel cell system of claim 17 further comprising a methanol fuel source in fluid communication with said anode loop.

19. The fuel cell system of claim 18 further comprising a methanol sensor in fluid communication with the exhaust port(s) wherein the signal from said fuel sensor is used to control the flow of methanol from said fuel source to said anode loop.

20. The fuel cell system of claim 11 comprising a plurality of said fuel cell assemblies, wherein a splitter upstream from the fuel entry ports for said assemblies delivers substantially the same amount of fuel to each of said fuel cell assemblies during operation.

21. A fuel cell comprising the fuel cell system of claim 11.

22. An electronic device comprising the fuel cell of claim 21.

23. A power supply comprising the fuel cell of claim 21.

24. An electric motor comprising the fuel cell of claim 21.
